(19) United States
(12) Patent Application Publication
(10) Pub. No.: US 2008/0142547 A1
(43) Pub. Date: Jun. 19, 2008

(54) LIQUIDS DISPENSING CONTAINER WITH SPOUTED FITMENT AND ANTI-BACKOFF AND ANTI-ROTATION FEATURES

(75) Inventors: Keith Jon Colacioppo, White Plains, NY (US); Richard Paul McNabb, Milford, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: CONOPCO, INC., d/b/a UNILEVER, Englewood Cliffs, NJ (US)

(21) Appl. No.: 11/757,416

(22) Filed: Jun. 4, 2007

Related U.S. Application Data
(60) Provisional application No. 60/869,747, filed on Dec. 13, 2006.

(51) Int. Cl. B67D 1/16; B65D 35/38

(52) U.S. Cl. 222/109; 222/566

(57) ABSTRACT

A liquids dispensing container is provided which includes a cap, a spout fitment and a bottle. The spout fitment includes a spout, an interior wall surrounding the spout, and an exterior wall surrounding the interior wall. The exterior wall has an upper and a lower circumferential edge. An anti-backoff window and an anti-rotation window are formed spacedly apart along the lower edge. The bottle includes a threaded finish, an open and a closed end, the open end receiving the spout fitment, an anti-backoff lug and an anti-rotation lug spacedly separated and positioned below threads of the finish projecting outwardly therefrom. The lugs are engageable within the respective anti-backoff and anti-rotation windows.

### BACKGROUND OF THE INVENTION

1. Field of the Invention

The invention concerns a liquids dispensing container with a spout fitment and cap, the fitment having anti-backoff and anti-rotation features coordinating with a finish of a bottle onto which are sealingly placed the fitment and cap.

2. The Related Art

Liquid forms of consumer products have steadily gained favor over semi-solids, powders and other formats. No doubt easy dispensability of liquids is a reason for their popularity. The trend is particularly evident in personal wash and laundry products. Flowability of liquids has the advantage of easy handling but suffers disadvantages of leakage during shipping and storage. In use, there also is the problem of messiness in pouring. Engineers have worked steadily to overcome these problems.

Liquid laundry dispensers have been provided with pour spouts that minimize drippage and feature drainback mechanisms. Illustrative is U.S. Pat. No. 5,108,009 (Davidson et al.) featuring a pouring spout and drainback fitment wedged into the mouth of a bottle. A cap with dual purpose as a measuring cup has a brim which is received within the well of the fitment. An outer circumferential wall of the cap has an inner threaded surface which mates with an exterior threaded finish of the bottle. A variant of this system is found in U.S. Pat. No. 4,696,416 (Muckenfuhs et al.). Therein an outer wall of the cap has exterior threads which seal with threads on an inner wall of the fitment.

A variety of drainback mechanisms are reported in U.S. Pat. No. 4,917,269 (Fuchs et al.), U.S. Pat. No. 4,890,770 (Haga et al.) and U.S. Pat. No. 5,941,422 (Struble).

Improvements in sealing are found in U.S. Pat. No. 6,209,762 B1 (Haffner et al.) and U.S. Pat. No. 5,649,650 (Klauke). These systems utilize appropriately positioned lugs around the finish areas. U.S. Pat. No. 6,964,359 B1 (Darr et al.) describes a container with a transition collar mounted onto the container finish. Outwardly extending spacedly separated projections along the finish engage the transition collar. Of particular note is U.S. Pat. No. 4,917,268 (Campbell et al.) describing a dispensing package featuring an interlock and centering means between finish and fitment. These means center the fitment with respect to the finish to assist the sealing system in preventing leaks as well as preventing rotation of the fitment when the cap is rotated out of engagement for removal.

Most of the features presented in the known art are directed towards consumer aesthetics. Yet demands of newer manufacturing systems have required manufacturers to develop improvements that meet production issues. One modern production line transports empty bottles along a conveyor, fills the bottles with liquid detergent, and then inserts a combination assembly of cap and unitarily molded fitment onto the filled bottle. Line speeds are very fast. The cap/fitment assembly spins at high speed above the bottle line and at those speeds spinningly engages threads of the bottle. This arrangement requires a mechanism to prevent the spouted fitment once inserted from again spinning off the bottle. Additionally there is required a mechanism for properly centering the spout of the fitment within the opening of the bottle. The present invention seeks to solve these manufacturing problems.

### SUMMARY OF THE INVENTION

A liquids dispensing container is provided which includes:
a cap;
a spout fitment including:
   a spout;
   an interior wall surrounding the spout;
   an exterior wall surrounding the interior wall, the exterior wall having an upper and a lower circumferential edge, the interior and exterior walls being joined along the upper circumferential edge, an anti-backoff window and an anti-rotation window formed spacedly apart along the lower circumferential edge, and screw threads formed along an inner surface of the exterior wall;
   a bottle including a threaded finish, an open and a closed end, the open end receiving the spout fitment, an anti-backoff lug and an anti-rotation lug spacedly separated and positioned below threads of the finish projecting outwardly therefrom, the lugs being engageable within the respective anti-backoff and anti-rotation windows, and the cap being sealably arranged over the fitment.

### DETAILED DESCRIPTION OF THE DRAWING

Various features, elements and benefits of the present invention will more fully be explained through consideration of the drawing in which:

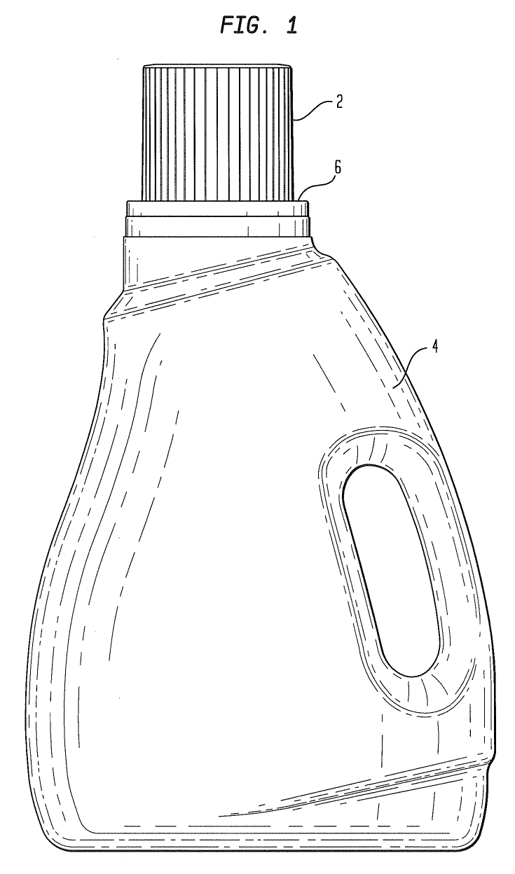

FIG. 1 is a side elevational view of one embodiment of a liquid dispensing container according to the present invention;

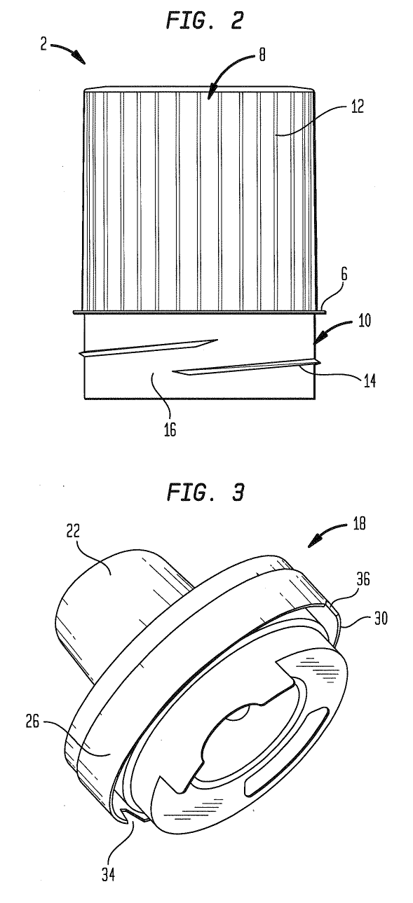

FIG. 2 is a side elevational view of a cap component of the invention illustrated in FIG. 1;

FIG. 3 is a plan perspective view of a spout fitment component of the container shown in FIG. 1;

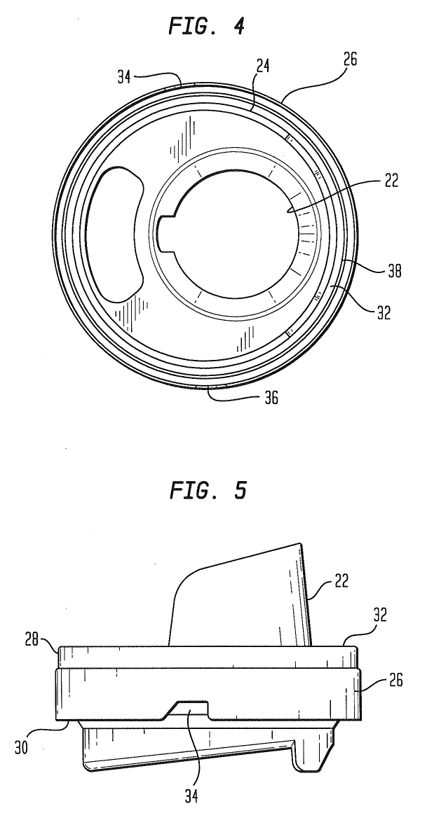

FIG. 4 is a bottom plan view of the fitment shown in FIG. 3;

FIG. 5 is a side elevational view of the fitment shown in FIG. 3;

FIG. 6 is a flattened view of a 200 degree circumferential section of the exterior wall of the spout fitment shown in FIG. 5;

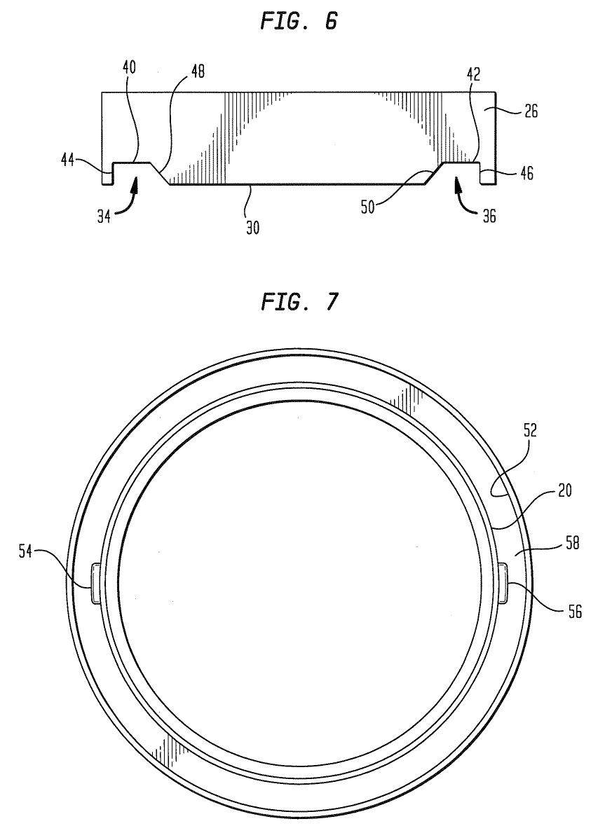

FIG. 7 is a top plan view of the bottle in the embodiment shown in FIG. 1;

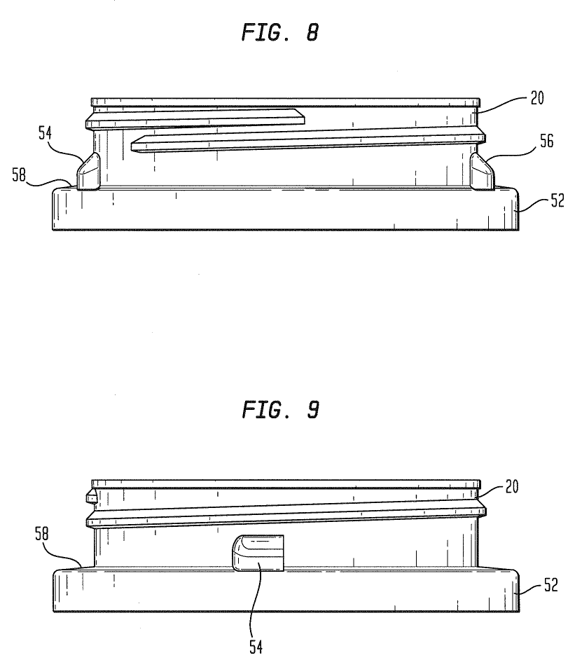

FIG. 8 is a partial view of the bottle shown in FIG. 7 focusing on the finish; and

FIG. 9 is the partial finish shown in FIG. 8 rotated 90 degrees.

### DETAILED DESCRIPTION OF THE INVENTION

FIG. 1 illustrates a first embodiment of the present invention. Therein is shown a liquids dispensing container having a cap 2 and a bottle 4 member. The cap as best illustrated in FIG. 2 includes a circumferential flange 6 separating an upper closed end portion 8 from a lower open end portion 10. A series of vertical ribs 12 are vertically arranged along a length direction of the upper closed end portion. A threaded projection 14 is formed on an external surface 16 of the lower open end portion. The cap when removed from sealing the bottle can serve as a measuring cup for dispensed liquid.

Spout fitment 18 is threadably engaged into an open end of the bottle and overlays a neck finish 20. The fitment best shown in FIG. 3-5 includes a spout 22, an interior wall 24 surrounding the spout, and an exterior wall 26 surrounding the interior wall. The exterior wall has an upper and a lower circumferential edge 28 and 30 respectively. A plastic web 32 joins these walls along the upper circumferential edge.

Anti anti-backoff window 34 and an anti-rotation window 36 are formed spacedly apart from each other along the lower edge of the exterior wall. Screw threads 38 are formed on an inner surface of the exterior wall 26.

FIG. 6 depicts in flattened format a section of the round exterior wall 26 of the spout fitment 18. This depiction allows a view of both the anti-backoff window 34 and the anti-rotation window 36. These windows are both open along the lower circumferential edge 30 of the exterior wall 26. Each window is configured with a horizontal ceiling wall 40, 42 and a vertical side wall 44, 46. The ceiling wall and vertical side wall of each window intersect at right angles. A fourth border of each window is formed with a slanted wall 48, 50. The ceiling wall and slanted wall of each window intersect to form an obtuse angle. Readily seen from FIG. 6 is that the slanted walls 48 and 50 taper toward one another. In other words, the slanted walls are oriented along lines that would intersect at a virtual point beneath the exterior wall.

FIGS. 7 and 8 illustrate an upper section of the bottle showing the neck finish 20 and a collar 52. An anti-backoff lug 54 and an anti-rotation lug 56 spaced apart 180 degree each project outward from the neck finish and rest on an upper surface 58 of the collar.

Consumer products packaged in the containers of this invention are manufactured in the following general manner. Empty bottles are transported on a conveyor belt system to a filling station along a production line. Liquid product such as laundry detergent or fabric softener is dosed from an overhead nozzle into an open mouth of the bottle. The filled bottle is then further transported downstream to a capping station. Here cap/fitment assemblies are spun at high speed.

A cap/fitment assembly is aligned with the filled bottle and inserted into the open mouth of the bottle. During insertion a window along the lower edge of the spinning fitment seats over a lug projecting from the bottle finish. This seating properly centers the spout relative to a parting line of the bottle. Shortly thereafter the other window on the fitment engages the second lug on the bottle finish. Now the assembly is secured against possibility of the fitment dislodging. A good seal is achieved against fluid leakage.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

All documents referred to herein, including all patents, patent applications, and printed publications, are hereby incorporated by reference in their entirety in this disclosure.

What is claimed is:

1. A liquids dispensing container comprising:
a cap;
a spout fitment comprising;
a spout;
an interior wall surrounding the spout;
an exterior wall surrounding the interior wall, the exterior wall having an upper and a lower circumferential edge, the interior and exterior walls being joined along the upper circumferential edge, an anti-backoff window and an anti-rotation window formed spacedly apart along the lower circumferential edge, and screw threads formed along an inner surface of the exterior wall;
a bottle comprising a threaded finish, an open and a closed end, the open end receiving the spout fitment, an anti-backoff lug and an anti-rotation lug spacedly separated and positioned below threads of the finish projecting outwardly therefrom, the lugs being engageable within the respective anti-backoff and anti-rotation windows, and the cap being sealably arranged over the fitment.

2. The liquids dispensing container according to claim 1 wherein the windows are each formed of walls one of which is slanted at an obtuse angle relative to another adjacent wall.

3. The liquids dispensing container according to claim 2 wherein each window is further formed with adjacent walls oriented toward one another at a right angle.

4. The liquids dispensing container according to claim 3 wherein the slanted wall of the anti-backoff window and the slanted wall of the anti-rotation window taper toward one another.

5. The liquids dispensing container according to claim 1 wherein the anti-backoff lug and the anti-rotation lug project from the neck finish and are positioned on a surface of an outwardly extending upper surface of a collar surrounding the neck finish.
